(19) United States
(12) Patent Application Publication
(10) Pub. No.: US 2021/0019429 A1
(43) Pub. Date: Jan. 21, 2021

(54) INTERNET OF THINGS DEVICES FOR USE WITH AN ENCRYPTION SERVICE

(71) Applicant: Jason Ryan COONER, Pinson, AL (US)

(72) Inventor: Jason Ryan COONER, Pinson, AL (US)

(21) Appl. No.: 16/980,841

(22) PCT Filed: Jan. 15, 2019
(86) PCT No.: PCT/US19/13719

§ 371 Date: Sep. 14, 2020

Related U.S. Application Data
(60) Provisional application No. 62/617,592, filed on Jan. 15, 2018.

(51) Int. Cl. G06F 21/60; H04L 9/08; G01R 21/133; G01J 1/42; G16Y 30/10; G16Y 20/30; G16Y 10/75

(52) U.S. Cl. CPC G06F 21/602; H04L 9/0819; G01R 21/133; G01J 2001/4266; G16Y 30/10; G16Y 20/30; G16Y 10/75; G01J 1/4204

(57) ABSTRACT

Embodiments of architecture, systems, and methods employ sensor data to encrypt data including creating a one-time pad (OTP) where the sensor data that may be generated from a sensor of an IoT system. Other embodiments may be described and claimed

### TECHNICAL FIELD

Various embodiments described herein relate generally to architecture, systems, and methods used to encrypt data.

### BACKGROUND INFORMATION

It may be desired to enable a User to encrypt data in a manner that cannot be decoded by current and future computer systems. The present invention provides an architecture, systems, and methods that enable a User to encrypt data in a manner that cannot be decoded by current and future computer systems.

### BRIEF DESCRIPTION OF THE DRAWINGS

FIG. 1 is a block diagram of a sensor data based encryption (SDBE) architecture according to various embodiments.

FIG. 2 is a diagram of communications between a User system, a encryption system, a sensor system, and a cloud server system according to various embodiments.

FIG. 3A is a block diagram of sensor architecture according to various embodiments.

FIG. 3B is a block diagram of another sensor architecture according to various embodiments.

FIG. 4 is a flow diagram illustrating several methods according to various embodiments.

FIG. 5 is a block diagram of an article according to various embodiments.

### DETAILED DESCRIPTION

In an embodiment, sensor data may be collected from a product or device including an Internet of Things sensor. The Internet of Things is a new style of architecture that may connect every product electronically, and most likely wirelessly, to the Internet. Many device manufacturers are currently building in sensors with radio communication that would allow the product's internal status, usage patterns, or other information regarding operation or process to be sent out via radio signal to hardware devices that can listen to their communication and transmit that communication to the Internet, or have a computer hardware or software system on the Internet that could send information to the product and have it respond in kind. This two-way communication between the product and the Internet is now being referred to as the “Internet of Things” computing architecture. The means by which the products may primarily communicate to the Internet may be through hardware devices known as gateways and/or routers that can send and/or receive the signals from the product. These communications may or may not occur over a cable and/or “short range” and/or “mid range” communications such as WIFI, RFID, ZigBee, Bluetooth, Openware (our own four-phase commit protocol described in detail in previously mentioned filings), LoRaWAN (LoRa), SigFox, cellular, satellite, or any other ad-hoc wireless communications protocol in any combination, and then send them to the Internet via a dedicated or intermittent Internet connection (which may be in turn wireline or wireless, or any other combination mentioned above). The routers or gateway devices that are currently available are devices such as Raspberry PI, Android devices, etc. Although these devices may work in limited capacity, they are in no way equipped to handle multiple short range transmission protocols “out of the box” and are not capable of connecting all products in a local environment to a single gateway or router device. One new router/gateway device design could be a hardware design that can scan a household, manufacturing facility, or other local region for wireless transmissions such as radio signals. Then decode the signal into raw data that the gateway/router device can understand. These wireless transmissions can be WIFI, RFID, ZigBee, Bluetooth, Openware, LoRaWAN (LoRa), SigFox, cellular, satellite, or any other form of “short range”, “mid range”, or “long range” radio signal protocol or airborne signal otherwise that may be used for IoT systems. Once the signal is decoded, the router can then scan for such signals on a scheduled interval or permanently as to act as a receiver for the signal detected. This may in turn allow the gateway/router to undergo an initial setup routine to decode all signals coming from any radio frequency enabled devices or products and then normalize them into a language the gateway/router can understand. The gateway/router can then transmit the normalized information from one or more devices or products to the Internet such as a cloud environment like Microsoft's Azure platform, Amazon's AWS (Web Services) platform, or some other computer network residing on the Internet or computer communications network. The data can then possibly be stored and/or used to drive business processes such as rules engines or business workflows in real time or at some point in the future. Such processes could include emailing parties when certain information indicates they be notified. As an example, if a refrigerator warms to a certain level that would indicate the cooling system is failing, then a service technician can be notified via text message, email, or other form of communication. The service technician can then be instructed to come out for a service check and possibly fix the refrigerator before all the food spoils. The gateway/router can also support devices being connected by cable directly as opposed to wirelessly for communications.

The scanning mechanism described above can be designed in the following ways. The gateway/router can first scan for a specified period to see which products are transmitting information and record which frequencies, baud rates, and/or additional product information can be picked up through real time detection and/or decryption and/or decoding of individual packets of wireless transmission data. All aspects of the different types of communication received from the product(s) in the local environment by the gateway/router should be recorded. The protocol format(s) that are detected can then be looked up via a database on the gateway/router and the product type(s) and wireless transmission type(s) can be recorded as a local wireless profile for the gateway/router to immediately and/or in the future. The information collected by the scan may also be sent to the Internet for decryption or decoding of the transmission type via a product wireless protocol catalog kept in a database on the Internet. The product type(s) and wireless transmission type(s) can then be send back to the gateway/router as a profile so the gateway/router knows how to communicate with each product in the local environment. This information can be stored and/or used for immediate and/or future use. Once the local “short range” or “mid range” network protocol(s) are deciphered and/or decoded and the gateway/router knows how to send and receive data transmissions to and from the product(s), then the gateway/router can then poll the different frequencies and baud rates to receive any transmissions from the products on a scheduled or one-time interval. The gateway/router may implement one or more antennas to perform the sending and receiving of transmissions to different products, if more than one product is sending and/or receiving transmissions. If a single antenna is used to communicate with multiple products, then the gateway/device may have to reprogram the antenna and/or computer logic on the gateway/device driving the antenna reception on a programmed time interval or for a single invocation to be able to send and receive on different wireless protocols on scheduled intervals. In other words, the antenna may have to be tunable to receive different frequencies and/or baud rates from potentially different pick parts and possibly additional information if needed to perform having a single antenna send and receive communications from multiple products. One example of this type of single antenna/multiple wireless protocol in use implementation is if there are five products that can transmit sensor information to the gateway/router. The gateway/router may need to cycle through the different protocols/product types profile created in the setup to scan for all product communications in a given interval at a rate that collectively doesn't exceed the maximum amount of time the products may try to resend information. In other words, if all five products may attempt to transmit for 1 minute before cancelling their transmission to the gateway/router, then the gateway/router may scan on each frequency and baud rate for no more than 12 seconds at a time in a single cycle so that the gateway/router can detect any transmission from any product before the product decides to cancel the transmission. Since there are 5 products in the local environment, 12 seconds of scan for communications from each product may result in 1 minute cycles for scanning all products. This may ensure that one gateway/router device always receives communication initiated by a product. If the gateway/router is designed with multiple antennas, each antenna could be utilized in a way to talk to multiple products or a single individual product per antenna. If each product has a dedicated antenna, then the cycling of scanning for an individual product can be eliminated as each antenna can be constantly listening for communications from each individual product. Additional information such as pick part type used by the manufacturer and any encryption-scheme specific information or other information may be needed to determine how to decrypt and/or decode the data from the products or transmit information to the products, both of which should be enabled by such a system. Specific product wireless profiles could be built into the gateway/router by the manufacturer and/or configured in advance of deployment, or pushed to the gateway/router so that the scanning mechanism is not needed and the gateway/router is shipped to the customer already configured to communicate with certain products and/or product types, or the wireless profile configuration can be controlled by an interface on the Internet via a cloud-based web interface or any other computer interface such as a mobile device, tablet, etc.

The gateway/router design should implement several security features that may ensure no firmware or data transmissions are ever tampered with or intercepted in clear text. This may require the data transmissions be encrypted from the sensor pack all the way through the gateway/router to the Internet as well as to the client interface. The firmware should be signed through a code certificate mechanism and written to read only data storage on all sensor packs as well as gateway/router devices to ensure no tampering with the hardware. A unique id should be assigned to each piece of hardware used in the system in advance of deployment so that each piece of equipment can be uniquely identified in the system. Data that is no longer needed should be erased from local memory so that no device can retain information sent to or received by the sensors. There should also be a transaction layer that begins at the sensor pack and/or Internet, whoever the originator of the transmission is, that may maintain integrity of communication all the way through the use of the system. This could be implemented as a two phase commit, as current Internet Protocol is designed, or it can be implemented as a four phase commit as described in previously filed patents referenced in the introduction of this patent filing. The gateway/router devices can be implemented in a chain of “grid enabled” devices so that the sensor pack may communicate with the Internet through several gateway/router devices en route during transmission.

Transactions could be used to push logic flow from the Internet to the sensor pack so that the sensor pack is capable of performing some of the logic that would normally be executed on the servers. This could lead to a more distributed computing model for systems based on the “Internet of Things” architecture as described herein. Sensor packs could be used to manipulate robots or perform other actions within products for a number of reasons. One could be for product maintenance. Another could be for product execution, such as running a dishwasher at a scheduled time, or turning on and off lights in a warehouse.

An additional gateway/router design could implement a “long range” wireless transmission protocol such as cellular, satellite, or other communications protocol that would not be considered “short range” or “mid range”, in addition to previously mentioned designs in this and previous filings referenced above. This would be done to wirelessly backhaul data transmissions to the Internet or have the Internet enabled system send transmissions to the gateway/router via a wireless “long range” transmission protocol.

The above described gateway/router designs could be used in conjunction with any of the sensor and sensor pack designs mentioned herein as well as in patents referenced in the introduction to this patent filing.

The “Edge” is the “Internet of Things”” (IoT for short) front-line of where technology intersects with business and people, capturing raw data used by the rest of the IoT system. Data is captured by embedding sensors in consumer devices (i.e. fitness trackers, thermostats) appliances or industrial systems (i.e. heating & cooling systems, factory automation) or more specialized applications such as remotely monitoring food temperature and humidity. Such devices can be referred to in this discussion as “Sensor Devices”. Data can then be passed to a “Router” and/or “Gateway” or other “Aggregation Points” that can provide some basic data analytics (parsing raw data) before being sent to the IoT Platform via an Internet connection and beyond. “Routers” can be thought of as local grid or mesh networks whereby implementations such as Bluetooth, ZigBee, WIFI, ANT, OpenWare, LoRa, SigFox, or other short to mid range wireless transmissions are used to communicate between Sensor Devices and Gateways. Gateways can be thought of as Internet-enabled hardware devices (usually through a wireless WIFI, cellular based such as GSM, CDMA, or other mobile phone carrier network, or landline connection) that communicate either directly to sensors, to sensors through Routers, or a hybrid of both Routers and sensors directly to allow for data to be passed bi-directionally to an Internet platform such as a cloud computing environment or computer network. Also, IoT is not just about capturing data but can also alter the operation of a device with an actuator or other configurable components.

The functionality, shape and size of “Edge” devices are mostly limited by human imagination since most of the technology already exists. For systems including a large number of devices or sensors, gateways and aggregation points serve as the primary connection point with the IoT platform and can collect and prepare data in advance sending the data to the IoT Platform.

Definitions of Edge Components

Environment: This is the operating environment of the sensor or device including natural environments (i.e. outside) or man-made (i.e. buildings, machinery or electronic devices). The environment is important when selecting the sensor to ensure it can withstand the ongoing demands of the environment in addition to power management and maintenance considerations of the “Edge” components.

Sensors: This is where the collection of IoT data begins. In most cases the raw data is analog and is converted to a digital format and sent through a serial bus (i.e. I2C) to a microcontroller or microprocessor for native processing. Typical sampling rates for sensors are 1,000 times per second (1 kilohertz) but can vary widely based on need.

Devices or “Things”: Sensors are typically embedded within existing devices, machines or appliances (i.e. wind turbines, vending machines, etc.) or in more complex systems such as oil pipelines, factory floors, etc. To eliminate sensors just sending a copious amount of raw data, some of these devices have basic analytical capabilities built-in which allow for some basic business rules to be applied (i.e. send an alert if the temperature exceeds 120 degrees Fahrenheit), as opposed to just sending a live data stream.

Routers: A router broadcasts a radio signal that is comprised of a combination of letters and numbers transmitted on a regular internal of approximately 1/10th of a second. They can transmit at this rate, but in an “intelligent” hardware scenario (Intelligent Sensors and/or Routers) the transmission may likely be much slower, as in 5-10 second intervals or exception based as needed. The term “Intelligent” simply means that there is application logic via software and/or firmware that may provide some logic or filtering of sensor data so that transmissions are only sent when conditions are met or a change in sensor data warrants an update to the network. Routers provide an added dimension “Edge” computing with the ability to combine the location of either Bluetooth, WiFi, ZigBee, ANT, OpenWare, LoRa, SigFox, or other short or mid-range wireless communication protocol equipped mobile devices (i.e. customers) and/or wired devices along with other factors such as current environmental and weather conditions. For example, by tracking the location of devices, more context relevant information can be pushed to the device such as special offers and recommendations based current conditions.

Aggregation Point or Gateway: The Gateway or Aggregation Point is the final stop before data leaves the “Edge”. While deploying a gateway is optional, it is essential when creating a scalable IoT system and to limit the amount of unneeded data sent to the IoT platform. Key functions include:

Convert the various data models and transport protocols used in the field, such as Constrained Application Protocol (CoAP), Advanced Message Queuing Protocol (AMQP), HTTP and MQTT, to the protocol(s), data model and API supported by the targeted IoT platform. The HTTP/HTTPS and MQTT are what the gateways may talk to the IoT Platform with. Other local protocols like serial, ZigBee, Bluetooth, WIFI, LoRa, SigFox, cellular, satellite, and/or Openware may normally be used from Router to Gateway.

Data consolidation and analytics (“Edge analytics”) to reduce the amount of data transmitted to the IoT platform so network bandwidth is not overwhelmed with meaningless data. This is especially critical when IoT systems include thousands of sensors in the field.

Real-time decisions that would take too much time if the data was first sent to the IoT Platform for analysis (i.e. emergency shut-down of a device).

Send data from legacy operational technology that may not have the ability to send data to an IoT platform.

Design Considerations

When thinking about the technology and design for the “Edge” of an IoT solution, business requirements are more important here than the technology itself, so IT personnel may have to work closely with the business to identify and meet the functionality, costs and security requirements. Once these business requirements are clearly understood does the technology selection process begin (i.e. sensors, gateways and design). At the same time, IT brings insights into the potential and capabilities provided by IoT technology which can help drive use case scenarios so collaboration between the business and IT is essential.

After defining the business requirements and the focus has shifted to the technical design of an IoT solution, it is important to first explore any unused IoT infrastructure already built into existing machinery, hardware and software (“Brownfield Opportunity”). There are many types of devices and machines out there already equipped with sensor type technology that is simply waiting to be tapped into. This is the low-hanging fruit that can be quickly leveraged with minimal disruption to the business because the technology has already been adopted while helping accelerate IoT initiatives. The “Greenfield Opportunity” is for IoT opportunities in enterprise environments where no existing IoT infrastructure exists.

There are two major deployment options for “Edge” devices used in an IoT solution:

“Edge” deployment without aggregation

“Edge” deployment with a gateway or aggregation point

No Aggregation: Every device is connected to a network (usually the Internet or other IP based system) enabling the device to send and receive data directly to the IoT Platform. This means each device must have a dedicated network and the ability send and receive data using APIs, the data model and transport protocol required by that IoT platform. The device must also have enough computing power for some analytics and to make real-time decisions such as turning off machine if the temperature passes a specified threshold. Finally, the device must have some sort of user interface for maintenance and ongoing updates.

Non-aggregated designs work best when there are few other devices in the area competing for connectivity. Usually, these devices also have more processing power, memory and an operating system capability so it is easier to add or adjust functionality. However, this added device capability is typically more expensive to implement and non-aggregated designs typically don't scale well with each device requiring individual attention to maintain and secure (unless the IoT Platform provides scalable “Edge” device management). Another potential challenge to consider is if the device does not support the IoT platform's transport protocol. In such cases, additional code may need to be added to each device so support the required APIs, data model and transportation protocol.

Aggregation: This design model includes a gateway or some other type of aggregation point connecting “Edge” devices and the IoT platform.

Aggregation designs are ideal for IoT implementations with a large number of sensors, a fleet of devices and where the devices are fixed and localized deployments. This is especially true for scaling and consolidating device management where multiple endpoints can be managed from a single location. Using gateways and other aggregation points in an IoT design allows for cheaper sensors and devices with less computing power while allowing for integration with legacy operational technology that otherwise may not have been available. Gateways can also consolidate the various protocols, data models and APIs from the various end points to the standards required by the IoT platform while also providing a location before data reaches the IoT platform for additional intelligence and intelligence to reduce the amount of data sent to the platform.

However, aggregated designs also provide another layer of complexity into the design by adding gateways or other aggregation points. This essentially means another link in the chain that needs to be monitored and addressed when there are issues. Additionally, without built-in redundancy into the design, this could also lead to a single point of failure when a gateway device goes down and all of the connected devices have no way of communicating with the IoT platform. As a result, all aggregation points must be designed with built-in redundancy.

Sensors

IoT sensors are basically a monitoring or measuring device embedded into machine, system or device with an API enabling it to connect and share data with other systems. However, sensors can create copious amounts of data which may have no practical value so analytics or exception based models are applied to reduce it to more of a meaningful dataset before transmission. Data is typically transmitted via an IEEE 802.1 network using an Internet Protocol (IP) to a gateway, router, receiver or aggregation point. The transmission frequency can be real-time streaming, exception-based, time intervals or when polled by another system.

The IoT sensor market is divided into two broad categories. Original Device Manufacturers (ODMs) and Original Equipment Manufacturers (OEMs). ODMs design manufacture the core sensor technology (pressure, temperature, accelerometers, light, chemical, etc.) with over 100,000 types of sensors currently available for IoT solutions. These sensors typically do not include any of the communication or intelligence capabilities needed for IoT solutions so OEMs embed ODM sensors into their IoT devices while adding the communications, analytics and other potential capabilities needed for their specified markets. For example, an OEM who builds a Building Automation IoT application may include various sensor types such as light (IR or visual), temperature, chemical (CO2), Accelerometer and contact.

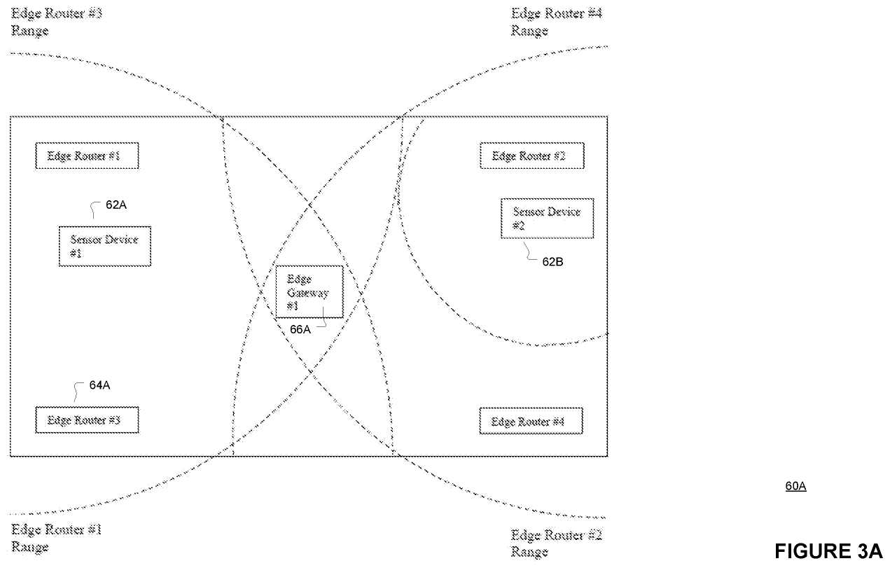

FIG. 3A is a block diagram of sensor architecture 60A according to various embodiments. FIG. 3B is a block diagram of another sensor architecture 60B according to various embodiments. As shown in FIGS. 3A and 3B, architecture 60A and 60B may include multiple sensors 62A, 62B that may be coupled to an Edge gateway 66A via one or more Edge routers 64A. An embodiment shown in FIG. 3B, may further include a WIFI gateway 68A in addition to the Edge gateway 66A. The gateways 66A, 68A may enable data to be communicated with the sensor devices 62A, 62B via another network.

The ODM marketplace is more consolidates and primarily includes established microelectronics and micro processing incumbents who already have the manufacturing facilities and market share such as ST Microelectronics, IBM, Robert Bosch, Honeywell, Ericsson, ARM Holdings and Digi International. On the flip side, the OEM marketplace more of the Wild West. It includes some of the industry heavyweights but is full of a new generation of startups seeking to capitalize on the IoT market. For example, we have Intel, Fujitsu, Hitachi and Panasonic, in addition to a slew of other companies such as Lanner, iWave, Artik, and Inventec. The scope of this paper does not include an in-depth analysis of the ODM and OEM vendor landscape.

The following diagram illustrates the typical layout of an IoT Wireless Sensor Device:

Current State-of-the-Union

Some of the major factors driving the growth of the IoT sensor market includes the development of cheaper, smarter and smaller sensors.

While the IoT sensor and device markets are exciting, dynamic and enjoying growth, the coming wave of these small, embedded, low-power, wireless and wearable devices still do not is enjoy ubiquitous and universal access to the Internet. Due to current battery constraints and longevity, these devices tend to rely on low-power communication protocols such as Bluetooth Low Energy (BLE) as opposed to the more connected and more power intensive protocols such as WiFi and cellular (GSM, 3G/4G, etc.). As a result, most of these devices require an application layer gateway capable of translating the communication protocols, APIs and data models to transmit to the Internet and IoT platform.

Future Trends

While the majority of IoT applications have traditionally been focused on driving operational efficiencies and cost savings, over the next 12 months, Gartner forecasts enhanced customer experience and new customer based revenue applications may take the lead in over the next 12 months.

The future growth of IoT sensors may be driven by the growing demand for smart devices and wearables, the need for real-time computing and applications, supportive government policies and initiatives, the deployment of IPv6 and the role of sensor fusion. Sensor Fusion is essential the current and future demands of IoT. Sensor Fusion combines data from multiple sensors in order to create a single data point for an application processor to formulate context, intent or location information in real-time for mobile, wearable and IoT devices. It is basically a setoff adaptive prediction and filtering algorithms to deliver more reliable results such as compensating for drift and other limitations of individual sensors.

By combining the growth projections of IoT (50 billion connected devices and a $7.1 trillion market) with the market focus on IoT sensor capability and performance, IoT sensors may be one of the most dynamic and explosive sectors in the market. There may continue to be new OEMs selling IoT applications but the market may also begin to consolidate as the market matures, communication standards are adopted and through M&A activity.

Baseline Requirements when Selecting a Sensor Device:

Security

Physical

Firmware

Data

Transmission

Power management

Battery life

Recharge Ability

Analytical capability

Sensors or devices producing large amounts of data or IoT systems using a large number of sensors may need to have analytical capability on the “Edge” to filter and select which data may be transmitted to the IoT Platform and beyond. Without “Edge” Analytics, the sheer volume of data can overload networks, create exorbitant communications costs and generate so much data that it becomes very difficult for it meaningful. Additional analytics may happen at the IoT Platform and enterprise applications using the data.

Exception based reporting . . .

Communication protocols

Wireless API

Device Maintenance Requirements . . .

GATEWAYS/ROUTERS/SENSOR . . .

Information from the “Edge” sensors can be integrated through an Internet enabled platform like an “IoT Platform” such as Microsoft's Azure IoT Platform to perform various services for the customer. Such services could also be integrated into a company's Enterprise Resource Planning or Customer Resource Management software to perform additional services such as scheduling a service call for a failing home appliance or notifying technical support that a particular robotic arm on a manufacturing floor is not operating correctly.

The “Edge” tier of an IoT architecture should consider using an application tier protocol for communicating with servers in an IoT Platform via a standard such as IoTivity from the Open Connectivity Foundation, the AllJoyn Framework from the AllSeen Alliance, or any other IoT specific protocol for application architecture. Such protocols may allow for Sensor Devices to be registered with an IoT Platform and then have them communicate one way or bi-directionally with the IoT Platform during operation. The “Edge” tier can also be integrated into a Device Manager service on the IoT Platform tier so that Sensor Devices, Routers, and/or Gateway Devices can be observed and managed on the IoT architecture. This may provide availability support so that all devices utilized on the “Edge” tier of the IoT architecture can be monitored and serviced as needed.

Blockchain Data Storage for IoT Implementations

The overall trading system technical architecture should implement a “blockchain” based transaction recording mechanism to reduce fraud and improve system reliability. According to Wiki: A blockchain—originally block chain—is a continuously growing list of records, called blocks, which are linked and secured using cryptography. Each block typically contains a hash pointer as a link to a previous block, a timestamp and transaction data. By design, blockchains are inherently resistant to modification of the data. A blockchain can serve as “an open, distributed ledger that can record transactions between two parties efficiently and in a verifiable and permanent way.” For use as a distributed ledger, a blockchain is typically managed by a peer-to-peer network collectively adhering to a protocol for validating new blocks. Once recorded, the data in any given block cannot be altered retroactively without the alteration of all subsequent blocks, which needs a collusion of the network majority.

Blockchains are secure by design and are an example of a distributed computing system with high Byzantine fault tolerance. Decentralized consensus has therefore been achieved with a blockchain. This makes blockchains potentially suitable for the recording of events, medical records, and other records management activities, such as identity management, transaction processing, documenting provenance, or food traceability.

Many aspects of the blockchain design are desirable for a commodity exchange and/or trading platform. However, a blockchain-based architecture isn't necessarily required to implement a carbon credit or expanded commodity exchange. Either form should support the notion of immediate buy/sell transactions, options, forwards and/or futures, and swaps.

The first work on a cryptographically secured chain of blocks was described in 1991 by Stuart Haber and W. Scott Stornetta. In 1992, Bayer, Haber and Stornetta incorporated Merkle trees to the blockchain as an efficiency improvement to be able to collect several documents into one block.

The first distributed blockchain was then conceptualized by an anonymous person or group known as Satoshi Nakamoto in 2008 and implemented the following year as a core component of the digital currency bitcoin, where it serves as the public ledger for all transactions. Through the use of a peer-to-peer network and a distributed timestamping server, a blockchain database is managed autonomously. The use of the blockchain for bitcoin made it the first digital currency to solve the double spending problem without requiring a trusted administrator. The bitcoin design has been the inspiration for other applications.

The words block and chain were used separately in Satoshi Nakamoto's original paper in October 2008, and when the term moved into wider use it was originally block chain, before becoming a single word, blockchain, by 2016. In August 2014, the bitcoin blockchain file size reached 20 gigabytes. In January 2015, the size had grown to almost 30 gigabytes, and from January 2016 to January 2017, the bitcoin blockchain grew from 50 gigabytes to 100 gigabytes in size.

By 2014, “Blockchain 2.0” was a term referring to new applications of the distributed blockchain database. The Economist described one implementation of this second-generation programmable blockchain as coming with “a programming language that allows users to write more sophisticated smart contracts, thus creating invoices that pay themselves when a shipment arrives or share certificates which automatically send their owners dividends if profits reach a certain level.” Blockchain 2.0 technologies go beyond transactions and enable “exchange of value without powerful intermediaries acting as arbiters of money and information”. They are expected to enable excluded people to enter the global economy, enable the protection of privacy and people to “monetize their own information”, and provide the capability to ensure creators are compensated for their intellectual property. Second-generation blockchain technology makes it possible to store an individual's “persistent digital ID and persona” and are providing an avenue to help solve the problem of social inequality by “potentially changing the way wealth is distributed”. As of 2016, Blockchain 2.0 implementations continue to require an off-chain oracle to access any “external data or events based on time or market conditions that need to interact with the blockchain”.

In 2016, the central securities depository of the Russian Federation (NSD) announced a pilot project based on the Nxt Blockchain 2.0 platform that would explore the use of blockchain-based automated voting systems. Various regulatory bodies in the music industry have started testing models that use blockchain technology for royalty collection and management of copyrights around the world. IBM opened a blockchain innovation research centre in Singapore in July 2016. A working group for the World Economic Forum met in November 2016 to discuss the development of governance models related to blockchain. According to Accenture, an application of the diffusion of innovations theory suggests that in 2016 blockchains attained a 13.5% adoption rate within financial services, therefore reaching the early adopters phase. In 2016, industry trade groups joined to create the Global Blockchain Forum, an initiative of the Chamber of Digital Commerce.

In early 2017, the Harvard Business Review suggested that blockchain is a foundational technology and thus “has the potential to create new foundations for our economic and social systems.” It further observed that while foundational innovations can have enormous impact, “It may take decades for blockchain to seep into our economic and social infrastructure.”

A blockchain facilitates secure online transactions. A blockchain is a decentralized and distributed digital ledger that is used to record transactions across many computers so that the record cannot be altered retroactively without the alteration of all subsequent blocks and the collusion of the network. This allows the participants to verify and audit transactions inexpensively. They are authenticated by mass collaboration powered by collective self-interests. The result is a robust workflow where participants' uncertainty regarding data security is marginal. The use of a blockchain removes the characteristic of infinite reproducibility from a digital asset. It confirms that each unit of value was transferred only once, solving the long-standing problem of double spending. Blockchains have been described as a value-exchange protocol. This blockchain-based exchange of value can be completed more quickly, more safely and more cheaply than with traditional systems. A blockchain can assign title rights because it provides a record that compels offer and acceptance.

A blockchain database consists of two kinds of records: transactions and blocks. Blocks hold batches of valid transactions that are hashed and encoded into a Merkle tree. Each block includes the hash of the prior block in the blockchain, linking the two. Variants of this format were used previously, for example in Git. The format is not by itself sufficient to qualify as a blockchain. The linked blocks form a chain. This iterative process confirms the integrity of the previous block, all the way back to the original genesis block. Some blockchains create a new block as frequently as every five seconds. As blockchains age they are said to grow in height.

Sometimes separate blocks can be produced concurrently, creating a temporary fork. In addition to a secure hash based history, any blockchain has a specified algorithm for scoring different versions of the history so that one with a higher value can be selected over others. Blocks not selected for inclusion in the chain are called orphan blocks. Peers supporting the database have different versions of the history from time to time. They only keep the highest scoring version of the database known to them. Whenever a peer receives a higher scoring version (usually the old version with a single new block added) they extend or overwrite their own database and retransmit the improvement to their peers. There is never an absolute guarantee that any particular entry may remain in the best version of the history forever. Because blockchains are typically built to add the score of new blocks onto old blocks and because there are incentives to work only on extending with new blocks rather than overwriting old blocks, the probability of an entry becoming superseded goes down exponentially as more blocks are built on top of it, eventually becoming very low. For example, in a blockchain using the proof-of-work system, the chain with the most cumulative proof-of-work is always considered the valid one by the network. There are a number of methods that can be used to demonstrate a sufficient level of computation. Within a blockchain the computation is carried out redundantly rather than in the traditional segregated and parallel manner.

By storing data across its network, the blockchain eliminates the risks that come with data being held centrally. The decentralized blockchain may use ad-hoc message passing and distributed networking. Its network lacks centralized points of vulnerability that computer crackers can exploit; likewise, it has no central point of failure. Blockchain security methods include the use of public-key cryptography. A public key (a long, random-looking string of numbers) is an address on the blockchain. Value tokens sent across the network are recorded as belonging to that address. A private key is like a password that gives its owner access to their digital assets or otherwise interact with the various capabilities that blockchains now support. Data stored on the blockchain is generally considered incorruptible.

Every node or miner in a decentralized system has a copy of the blockchain. Data quality is maintained by massive database replication and computational trust. No centralized “official” copy exists and no user is “trusted” more than any other. Transactions are broadcast to the network using software. Messages are delivered on a best effort basis. Mining nodes validate transactions, add them to the block they are building, and then broadcast the completed block to other nodes. Blockchains use various time-stamping schemes, such as proof-of-work, to serialize changes. Alternate consensus methods include proof-of-stake and proof-of-burn. Growth of a decentralized blockchain is accompanied by the risk of node centralization because computer resources required to operate bigger data become more expensive.

The blockchain mechanism could be used for registering users of the IoT implementation, as well as registering all the equipment necessary to implement the carbon credit/allowance/certificate/etc generation and monitoring software platform, potentially in a Cloud-computer based environment. One could foresee the blockchain implementation within a single Cloud-computing environment, or spanning across two or more Cloud-computing environments. If the blockchain implementation was spread across multiple Clouds, this would increase security as well as availability and stability of the entire system. All transactions could be recorded by the blockchain so that the entire IoT implementation benefits from the blockchain's benefits.

Blockchain can be implemented in a manner that allows for the following attributes:

No unnecessary global sharing of data: only parties with a legitimate need to know can see the data within an agreement

The blockchain choreographs workflow between firms without a central controller

The blockchain achieves consensus at the level of individual deals between firms, not at the level of the system

The design directly enables supervisory and regulatory observer nodes

Transactions are validated by the parties to the transaction rather than a broader pool of unrelated validators

The blockchain supports a variety of consensus mechanisms

The blockchain records an explicit link between smart contract code and human-language legal documents

The blockchain is built on industry-standard tools

The blockchain may or may not have any native cryptocurrency

Each node on a blockchain network has a vault, and each vault has “facts”. Each fact in effect represents a SQL database record, whose access and visibility can be controlled by the node itself. So, in an IoT network, the IoT devices need to register with a blockchain for purposes of registering with the network. Once registered via a blockchain to contain identification and technical properties of the IoT device, then the IoT device may transmit information directly to a blockchain, potentially based on blockchain attributes, that may create an immutable record of the IoT device's transmission as well as contents of the transmission. This immutable record may be used to verify carbon credits for the participating system. The carbon credit, once processed and created, may be stored in a blockchain. The blockchain may potentially be the same ledger as the original records, or a separate blockchain that is only utilized for referencing the carbon credit itself. This is a necessary distinction because the ledger collecting data may be preferred for storing the resulting carbon credit, or in cases where it isn't, the carbon credit can be stored in an additional ledger. Once the carbon credit is created, a smart contract can be used to sell or trade the credit. If the blockchain ledger is created and smart contracts are maintained properly, then the entire system can lead to a highly secure environment for managing GHG programs from data collection to monetization of the carbon credit.

The blockchain facilitates trusted peer to peer transactions through smart contracts that reflect existing legal and business relationships without the need for an intermediary. The blockchain was built for business from the start and has no crypto currencies and no mining. This creates massive efficiencies for bottom line savings while opening up new top line revenue opportunities. The blockchain enables firms to move from internal records and complex systems to transact, to global authoritative systems of record shared directly between firms. Authoritative facts are recorded on ledger, enabling settlement or trade to occur directly across the platform. This point to point system is a fundamental architectural difference from other systems.

The IoT device may potentially implement GPS to confirm during operation that it hasn't been moved or tampered with in an attempt to alter the IoT device's output to the blockchain. This GPS coordinate and/or location otherwise, along with the serial number of the device could be used in a cryptographic scheme to verify the device is accurate and verifiable during operation.

The biggest challenge for Blockchain platforms is ensuring privacy of transactions. The blockchain enables transaction privacy by sharing transactions only with parties involved in a transaction. The blockchain's unique point-to-point architecture uses a pluggable uniqueness consensus mechanism that can be operated as a service. The end state for Blockchain networks is one where any party can transact freely and without constraint. Ledger assets must not be trapped within separate networks or require complex network integrations. The blockchain can enable a global network of nodes that are free to transact openly with any other node while still supporting private business networks.

The basic aspect of merging carbon credits with a live trading market is that the verification/validation process only has to be done once as the smart contract of a blockchain can be tailored to model the verification from the certification of the verification process on so that the verification process cannot be compromised. In doing so, the carbon credits generated don't have to be questioned as they are already confirmed as accurate. Then the carbon credits can be traded without question as to accuracy and/or authenticity.

So, in the proposed modified blockchain implementation dedicated to carbon credit generation and monetization, the process works like below:

IoT device or other measurement equipment sends relevant data to the blockchain, which is immediately committed after a technical review to confirm that the data is valid and from the intended source.

The blockchain may implement through a smart contract, simple vault, direct messaging, or some other design to contact a carbon credit verification body on a timed interval to calculate carbon credits.

The verification body may act on its' own to access the blockchain on intervals to calculate carbon credits as needed.

This could mean that the verification body is responsible for committing the data transmitted by the IoT device in a real-time manner, on a timed interval, or otherwise. What is most important is that the verification body is responsible for reviewing data sent by IoT devices under its authority, assignment, or management. In doing so, only valid data from IoT devices should be validated and/or verified for use in carbon credit calculations.

Once the verification body calculates carbon credits/allowances/offsets/etc. and registers them in the same or another blockchain, the carbon credits/allowances/offsets/etc. can be submitted to a carbon trading market for trade or purchase.

The blockchain implementation should be able to perform this from a single blockchain ledger, or multiple that are congruent to each other. In doing so, the implementation overall can maintain integrity, security, authenticity, and accuracy in trading the carbon credits/allowances/offsets/etc.

So, the rules for the scenario mentioned are as follows:

IoT devices should be registered and verified by a blockchain before allowing the devices to participate in communication with the blockchain.

Once devices are registered for use by a given blockchain, they can begin to transmit data to the blockchain as logic on the IoT device allows.

As a transmission is sent to the blockchain, it should be fully encrypted en route.

Once received by the blockchain, the data should be committed.

The data should be available initially only to the assigned verification body for analysis.

Once the verification body has analyzed the data, it should confirm that the data is valid and is used in calculation of carbon credits/allowances/offsets/etc.

After the verifier calculates carbon credits based on a given set of data, then the carbon credits/allowances/offsets/etc. should be submitted to a market for purchase or trade, either in real time, on a scheduled interval, or on scheduled times.

There are many versions of a “blockchain” implementation. This disclosure describes a few potential versions. Blockchains are described as a sequence of blocks consisting of a transaction that is joined with a block of data. The transaction and associated data represent a block of information. The block is potentially run through an encryption algorithm known as a hash function, and the result is stored in the previous block as a reference to the block that follows. In this manner, each block has an encrypted reference as to the location of the next block in the chain. Hence, a block chain. However, that is an implementation that can be run on a single standalone computing device.

In a cloud environment, one could implement data storage of a “block” as described above involving a transaction and a set of data in another manner. Take for instance RAID storage, whereby data is written across multiple hard drives on a single computer. If you think of writing a block or just the data itself across multiple servers as if each server was another drive in a RAID storage mechanism, then you can record blocks or individual data records across a cluster of data storage servers as if each server was a physical drive in a RAID array. Where it gets interesting from a security standpoint is if you treat a cluster of servers in a manner consistent with RAID 5, 6, or higher involving striping, mirroring, and/or parity to record data. But with an extra security layer. What if a segment of the data and/or transaction in a block was encrypted and then written to a different server with a hash of the location/network address of the corresponding block parts to other servers. This could be done in a manner consistent with any RAID storage mechanism such as striping, mirroring, and/or parity except each server or servers in a cluster are treated as physical drives in a RAID array. This would have the effect of having a software abstraction layer that understands a specific encryption scheme across the entire cluster where the blocks are stored. However, this scheme would not allow anyone who has access to the storage space only on each server be able to recover any data without decrypting all the servers in the cluster and then piecing the files back together. The software used to write blocks across the server cluster would be the only means by which data can be easily recovered. This scheme would provide significant additional security to any storage facility well beyond what is currently available in a single database server or single database server clustered environment.

So, in considering the previous example, apply RAID 5 or 6 to a cluster of servers. If you write part of one block to one server, and another part to another server, and another part to another server, and then another part to a fourth server, with parity to all other servers, then one server can crash and the data can still be recovered. However, if using the encryption scheme above for each segment of the file (or potentially a block as described), then a server in the cluster can crash or be otherwise unavailable and the data/block is still safe from hackers or unwanted access, but potentially still recoverable and accessible by the software managing the storage scheme.

As discussed previously, measurements for carbon based allowances or offsets can be calculated and stored in a blockchain based architecture. In the case that the carbon-based measurements (renewable, efficiency, water, etc.) are stored in a blockchain, then that same or an additional blockchain implementation can provide what is referred to as a “cryptocurrency” based on the carbon values provided. In other words, in this mechanism, a “cryptocurrency” can be “backed by” carbon based certificates, credits, or any other form of carbon instrument.

What this may facilitate is the usage of a cryptocurrency that may be instituted by carbon savings, and may support reinvestment of associated profits, residuals, or other means of monetization into additional mechanisms that encourage or accelerate adoption of environmentally efficient practices. Any market that subscribes to this business model must require some of the profits to be directly and/or indirectly invested into projects that could potentially deliver renewable energy or energy efficiencies into actual use, or may introduce energy efficient methods into commercialization in the future.

To expand on the concept, this blockchain may allow for valuations such as “BitCoin” to be generated by computing processes involving algorithms, but the same platform/market may also allow for creation of valuations that may represent valuations on the same market that may be created by entities producing renewable energy and/or energy efficiencies in the energy market. This merging of existing carbon instruments with cryptocurrency instruments can introduce an entirely new financial market that allows for digital currency and energy efficiency to benefit from, assimilate to, and profit with each other moving forward.

One possible strategy could be for every cryptocurrency unit that is processed, or “mined”, on this carbon-associated market, then a percentage of the currency is dedicated to achieving carbon efficiencies. This could be augmented by participating entities that are reducing carbon usage or producing renewable energy by allowing their activities to also produce cryptocurrency units in an equivalent monetary value, or in a scale that is deemed fair in relation to the cryptocurrency markets. Other models may include purchasing cryptocurrency but specifying a percentage of the purchase go towards energy efficiency efforts. Another could simply have an agreed to purchase or ongoing valuation of the cryptocurrency unit automatically being utilized at a time specified by the instrument, market, seller or buyer to be utilized in carbon reduction. In doing so, this mechanism would elevate both the cryptocurrency market and the carbon market in potential value, ownership, and interest.

Another possible strategy could be for the producer of the renewable energy/carbon allowance, credit or certificate to allow a partial value of that effort to go towards “backing” or endorsing a cryptocurrency unit. This would allow for the carbon market benefits to be realized in the cryptocurrency market. In other words, when a cryptocurrency unit is created, it is directly and/or indirectly attached to a carbon reduction benefit. Alternately, when a carbon offset/allowance/credit is generated by the energy provider/consumer, that carbon instrument can automatically be converted to a cryptocurrency unit in part or in full to realize monetization.

The monetization of carbon allowances/offsets/credits/certificates has been historically an obscure process involving registries alongside carbon markets that have implemented a variety of trading barriers. By monetizing carbon benefits in this manner and attaching them to cryptocurrencies in any of the above-mentioned strategies or otherwise, the move to reduce carbon emissions may be dramatically accelerated.

There is a notion of a carbon “registry”, whereby Greenhouse Gas (GHG) Emissions Programs are registered per ISO 14064 and ISO 14065 standards. These “registries” can also be integrated into the aforementioned blockchain architecture. Although they can also be maintained outside the blockchain, it is recommended that any future carbon registry be implemented on a blockchain to increase security, reduce volatility and fraud, as well as maintain a consistent data storage mechanism. If a carbon registry were to implement its storage on a blockchain, it could ensure no replication of carbon certificates/allowances/credits are issued, as well as ensure no fraudulent records are produced.

The current carbon registries allow entities to register GHG emissions programs, and if approved, from approval date on the registries allow the entities that own or manage the GHG emissions program to receive carbon certifications/allowances/offsets/credits/etc. based on future efficiencies/renewable power production. There is no guarantee that the future carbon certifications/allowances/offsets/credits/etc. are valid as most participants submit billing statements/monthly reports/etc. to verify power usage. This is not exact or precise in any way and can create fraudulent practices. The recommended mechanism after a GHG emissions program is approved is to have some form of electronic wattage or water usage meter that can automatically transmit data on a standardized interval up to an Internet enabled network, preferably a Cloud-based data storage facility. To improve the accuracy and security of the data being transmitted, it should be encrypted from the measurement device all the way to the data storage facility. To further improve the integrity of the system, the data storage facility should be based on a blockchain implementation as that would implement an “immutable” data storage implementation on the Cloud. Regardless of what storage implementation is used, the “registry” as well as the data storage implementation used to back up the metering devices should be an “immutable” data storage facility. In other words, all aspects of the aforementioned system as well as the implementations described in the referenced provisional patent applications filed previously should incorporate data storage facilities that support full data encryption as well as insertion of data that cannot be altered once submitted.

The cryptocurrency model described herein may potentially allow entities that produce renewable energy or energy efficiencies to be issued corresponding cryptocurrency units instead of carbon certificates/allowances/offsets/etc. on a carbon market, or issued carbon instruments that can be converted into cryptocurrency. Or, as an alternate plan, the carbon markets could adopt a more fluid environment much like the cryptocurrency markets have enabled. By linking carbon and cryptocurrency, the concept allows digital currency to be ensured by carbon offsets. The significance of this is that currently digital currency has no limited-availability commodity associated with it. For instance, most first-world currencies are “backed” by gold, hence the “gold standard”. This means that the currency issued has some physical assurance that it is actually worth something. Although this standard hasn't been fully maintained, the concept still applies. However, no digital currency is backed by any limited resource. It makes a lot of sense to have a digital currency to be endorsed, or “backed” by carbon allowances/certificates/credits/etc. If a digital currency supports an association with carbon reduction, it can potentially accelerate the reduction of fossil fuels. This concept could be referred to as the “carbon standard”.

Another model could be that each cryptocurrency unit that is generated through “data mining” or computer processing is done so with the understanding that a certain percentage of it's worth is applied towards reducing carbon emissions in some capacity. This could serve to promote renewable energy production or energy efficiency efforts. The simplification of carbon allowances/certificates/offsets/etc. would be benefitted if they were normalized on both the renewable energy production side as well as the energy efficiency consumption side. If normalized, both the production and consumption side could be represented as a single commodity, or carbon instrument.

In addition to the above models, the carbon instruments can then be converted into a unit of cryptocurrency and stored in a blockchain implementation of any of the variations mentioned in this disclosure. The same blockchain could also support “data mining” for cryptocurrency creation similar how to “Bitcoin” works. By supporting creation of cryptocurrency units in a single cryptocurrency market via energy efficiencies and/or renewable or “greener” energy production as well as data mining, this market could allow individuals as well as companies such as utilities to participate in a cryptocurrency market that is designed to promote carbon efficiencies and/or renewable or more environmentally safe energy sources. Some of the proceeds from the sale and/or trade of this type of cryptocurrency could be used to build and maintain renewable energy production facilities like solar and wind farms, or be used to implement energy efficiency programs on buildings in say, for instance, economically challenged geographic areas. This could in turn facilitate additional carbon offset/certificate/allowance production that could be used to generate additional cryptocurrency units for years to come.

Yet another aspect of this cryptocurrency market could be to support at any time the cryptocurrency units being converted back into carbon offsets/certificates/allowances/etc. for use by an entity in achieving carbon reduction goals or to hold as a carbon-based instrument that can later be reconverted back into a cryptocurrency unit. These cryptocurrency units could be referred to as carbon coins, carbon currency, or some similar suitable name that references the association with carbon reduction programs.

The above carbon-based cryptocurrency market schemes may or may not incorporate any of the aspects mentioned in U.S. Provisional Application No. 62/581,746, filed November 5th 2017, as well as U.S. Provisional Application No. 62/582,918 filed Nov. 7, 2017. This may or may not include any provisions laid out in ISO standards 14064 parts 1-3, 14065, or 14066 in implementation. This may or may not include any of the validation and/or verification mechanisms for creating carbon based offset/allowance/certificate/credits/etc. of any form to create an instrument or means by which to create a cryptocurrency unit.

By implementing these models for creating and managing a cryptocurrency market, one may in effect eliminate the need for existing carbon markets as they are based on government enforcement of carbon reduction incentivization schemes like cap-and-trade policies as well as similar mechanisms to ensure/promote enforcement by participating companies and/or utilities. These new mechanisms disclosed herein may create incentivization to participate in carbon reduction and clean energy production for the purposes of creating cryptocurrency units that can be immediately and/or actively traded for cash on a cryptocurrency market. By the same notion, people/entities wanting to data mine cryptocurrency can also participate in the same or another dedicated cryptocurrency market that may set-asides and direct investment strategies identified in this disclosure to create new clean energy sources and energy efficiency implementations. These investment strategies may include investment in other inventions that promote clean energy production or energy efficiencies and/or direct construction of new clean energy sources. These investment strategies may include a percentage of the creation and/or trading of the cryptocurrency units themselves from the carbon validation/verification side as well as from the data mining side of the market. This can also be accomplished by two separate cryptocurrency markets, one dedicated to carbon offsetting/reduction efforts while another is dedicated to data mining similar to what “Bitcoin” is performing today.

One Time Pad

As known to those of skill in the art, one format of one-time pad used by the U.S. National Security Agency is code named DIANA.

In cryptography, the one-time pad (OTP) is an encryption technique that cannot be cracked, but requires the use of a one-time pre-shared key the same size as, or longer than, the message being sent. In this technique, a plaintext is paired with a random secret key (also referred to as a one-time pad). Then, each bit or character of the plaintext is encrypted by combining it with the corresponding bit or character from the pad using modular addition. If the key is truly random, is at least as long as the plaintext, is never reused in whole or in part, and is kept completely secret, then the resulting ciphertext may be impossible to decrypt or break. It has also been proven that any cipher with the perfect secrecy property must use keys with effectively the same requirements as OTP keys. However, practical problems have prevented one-time pads from being widely used.

First described by Frank Miller in 1882, the one-time pad was re-invented in 1917. On Jul. 22, 1919, U.S. Pat. No. 1,310,719 was issued to Gilbert S. Vernam for the XOR operation used for the encryption of a one-time pad. Derived from his Vernam cipher, the system was a cipher that combined a message with a key read from a punched tape. In its original form, Vernam's system was vulnerable because the key tape was a loop, which was reused whenever the loop made a full cycle. One-time use came later, when Joseph Mauborgne recognized that if the key tape were totally random, then cryptanalysis would be impossible.

The “pad” part of the name comes from early implementations where the key material was distributed as a pad of paper, so that the top sheet could be easily torn off and destroyed after use. For ease of concealment, the pad was sometimes reduced to such a small size that a powerful magnifying glass was required to use it. The KGB used pads of such size that they could fit in the palm of a hand, or in a walnut shell. To increase security, one-time pads were sometimes printed onto sheets of highly flammable nitrocellulose, so that they could be quickly burned after use.

There is some ambiguity to the term because some sources use the terms “Vernam cipher” and “one-time pad” synonymously, while others refer to any additive stream cipher as a “Vernam cipher”, including those based on a cryptographically secure pseudorandom number generator (CSPRNG).

One Time Pad History

Frank Miller in 1882 was the first to describe the one-time pad system for securing telegraphy.

The next one-time pad system was electrical. In 1917, Gilbert Vernam (of AT&T Corporation) invented and later patented in 1919 (U.S. Pat. No. 1,310,719) a cipher based on teleprinter technology. Each character in a message was electrically combined with a character on a paper tape key. Joseph Mauborgne (then a captain in the U.S. Army and later chief of the Signal Corps) recognized that the character sequence on the key tape could be completely random and that, if so, cryptanalysis would be more difficult. Together they invented the first one-time tape system. [11]

The next development was the paper pad system. Diplomats had long used codes and ciphers for confidentiality and to minimize telegraph costs. For the codes, words and phrases were converted to groups of numbers (typically 4 or 5 digits) using a dictionary-like codebook. For added security, secret numbers could be combined with (usually modular addition) each code group before transmission, with the secret numbers being changed periodically (this was called superencryption). In the early 1920s, three German cryptographers (Werner Kunze, Rudolf Schauffler and Erich Langlotz), who were involved in breaking such systems, realized that they could never be broken if a separate randomly chosen additive number was used for every code group. They had duplicate paper pads printed with lines of random number groups. Each page had a serial number and eight lines. Each line had six 5-digit numbers. A page would be used as a work sheet to encode a message and then destroyed. The serial number of the page would be sent with the encoded message. The recipient would reverse the procedure and then destroy his copy of the page. The German foreign office put this system into operation by 1923.

A separate notion was the use of a one-time pad of letters to encode plaintext directly as in the example below. Leo Marks describes inventing such a system for the British Special Operations Executive during World War II, though he suspected at the time that it was already known in the highly compartmentalized world of cryptography, as for instance at Bletchley Park.

The final discovery was by Claude Shannon in the 1940s who recognized and proved the theoretical significance of the one-time pad system. Shannon delivered his results in a classified report in 1945, and published them openly in 1949.[4] At the same time, Vladimir Kotelnikov had independently proved absolute security of the one-time pad; his results were delivered in 1941 in a report that apparently remains classified.

### Example

Suppose Alice wishes to send the message “HELLO” to Bob. Assume two pads of paper containing identical random sequences of letters were somehow previously produced and securely issued to both. Alice chooses the appropriate unused page from the pad. The way to do this is normally arranged for in advance, as for instance ‘use the 12th sheet on 1 May’, or ‘use the next available sheet for the next message’.

The material on the selected sheet is the key for this message. Each letter from the pad may be combined in a predetermined way with one letter of the message. (It is common, but not required, to assign each letter a numerical value, e.g., “A” is 0, “B” is 1, and so on.)

In this example, the technique is to combine the key and the message using modular addition. The numerical values of corresponding message and key letters are added together, modulo 26. So, if key material begins with “XMCKL” and the message is “HELLO”, then the coding would be done as follows:
H E L L O message
7 (H) 4 (E) 11 (L) 11 (L) 14 (O) message
+23 (X) 12 (M) 2 (C) 10 (K) 11 (L) key
=30 16 13 21 25 message+key
=4 (E) 16 (Q) 13 (N) 21 (V) 25 (Z) (message+key) mod 26
E Q N V Z ? ciphertext

If a number is larger than 26, then the remainder after subtraction of 26 is taken in modular arithmetic fashion. This simply means that if the computations “go past” Z, the sequence starts again at A.

The ciphertext to be sent to Bob is thus “EQNVZ”. Bob uses the matching key page and the same process, but in reverse, to obtain the plaintext. Here the key is subtracted from the ciphertext, again using modular arithmetic:
E Q N V Z ciphertext
4 (E) 16 (Q) 13 (N) 21 (V) 25 (Z) ciphertext
23 (X) 12 (M) 2 (C) 10 (K) 11 (L) key
=−19 4 11 11 14 ciphertext-key
=7 (H) 4 (E) 11 (L) 11 (L) 14 (O) ciphertext-key (mod 26)
H E L L O ? message

Similar to the above, if a number is negative then 26 is added to make the number zero or higher.

Thus Bob recovers Alice's plaintext, the message “HELLO”. Both Alice and Bob destroy the key sheet immediately after use, thus preventing reuse and an attack against the cipher. The KGB often issued its agents one-time pads printed on tiny sheets of “flash paper”—paper chemically converted to nitrocellulose, which burns almost instantly and leaves no ash.

The classical one-time pad of espionage used actual pads of minuscule, easily concealed paper, a sharp pencil, and some mental arithmetic. The method can be implemented now as a software program, using data files as input (plaintext), output (ciphertext) and key material (the required random sequence). The XOR operation is often used to combine the plaintext and the key elements, and is especially attractive on computers since it is usually a native machine instruction and is therefore very fast. However, it is difficult to ensure that the key material is actually random, is used only once, never becomes known to the opposition, and is completely destroyed after use. The auxiliary parts of a software one-time pad implementation present real challenges: secure handling/transmission of plaintext, truly random keys, and one-time-only use of the key.

Attempt at cryptanalysis

To continue the example from above, suppose Eve intercepts Alice's ciphertext: “EQNVZ”. If Eve had infinite time, she would find that the key “XMCKL” would produce the plaintext “HELLO”, but she would also find that the key “TQURI” would produce the plaintext “LATER”, an equally plausible message:
4 (E) 16 (Q) 13 (N) 21 (V) 25 (Z) ciphertext
19 (T) 16 (Q) 20 (U) 17 (R) 8 (I) possible key
=−15 0 −7 4 17 ciphertext-key
=11 (L) 0 (A) 19 (T) 4 (E) 17 (R) ciphertext-key (mod 26)

In fact, it is possible to “decrypt” out of the ciphertext any message whatsoever with the same number of characters, simply by using a different key, and there is no information in the ciphertext which may allow Eve to choose among the various possible readings of the ciphertext.

Perfect Secrecy

One-time pads are “information-theoretically secure” in that the encrypted message (i.e., the ciphertext) provides no information about the original message to a cryptanalyst (except the maximum possible length of the message). This is a very strong notion of security first developed during WWII by Claude Shannon and proved, mathematically, to be true for the one-time pad by Shannon about the same time. His result was published in the Bell Labs Technical Journal in 1949. Properly used, one-time pads are secure in this sense even against adversaries with infinite computational power.

Claude Shannon proved, using information theory considerations, that the one-time pad has a property he termed perfect secrecy; that is, the ciphertext C gives absolutely no additional information about the plaintext. This is because, given a truly random key which is used only once, a ciphertext can be translated into any plaintext of the same length, and all are equally likely. Thus, the a priori probability of a plaintext message M is the same as the a posteriori probability of a plaintext message M given the corresponding ciphertext. Mathematically, this is expressed as H(M)=H(M|C), where H(M) is the entropy of the plaintext and H(M|C) is the conditional entropy of the plaintext given the ciphertext C. Perfect secrecy is a strong notion of cryptanalytic difficulty.

Conventional symmetric encryption algorithms use complex patterns of substitution and transpositions. For the best of these currently in use, it is not known whether there can be a cryptanalytic procedure which can reverse (or, usefully, partially reverse) these transformations without knowing the key used during encryption. Asymmetric encryption algorithms depend on mathematical problems that are thought to be difficult to solve, such as integer factorization and discrete logarithms. However, there is no proof that these problems are hard, and a mathematical breakthrough could make existing systems vulnerable to attack.

Given perfect secrecy, in contrast to conventional symmetric encryption, OTP is immune even to brute-force attacks. Trying all keys simply yields all plaintexts, all equally likely to be the actual plaintext. Even with known plaintext, like part of the message being known, brute-force attacks cannot be used, since an attacker is unable to gain any information about the parts of the key needed to decrypt the rest of the message. The parts that are known may reveal only the parts of the key corresponding to them, and they correspond on a strictly one-to-one basis; no part of the key is dependent on any other part.

Problems

Despite Shannon's proof of its security, the one-time pad has serious drawbacks in practice because it requires:

Truly random (as opposed to pseudorandom) one-time pad values, which is a non-trivial requirement. See Pseudorandom number generator.

Secure generation and exchange of the one-time pad values, which must be at least as long as the message. (The security of the one-time pad is only as secure as the security of the one-time pad exchange).

Careful treatment to make sure that it continues to remain secret, and is disposed of correctly preventing any reuse in whole or part—hence “one time”. See data remanence for a discussion of difficulties in completely erasing computer media.

One-time pads solve few current practical problems in cryptography. High quality ciphers are widely available and their security is not considered a major worry at present. Such ciphers are almost always easier to employ than one-time pads; the amount of key material which must be properly generated and securely distributed is far smaller, and public key cryptography overcomes this problem.

Key Distribution

Further Information: Key Distribution

Because the pad, like all shared secrets, must be passed and kept secure, and the pad has to be at least as long as the message, there is often no point in using one-time padding, as one can simply send the plain text instead of the pad (as both can be the same size and have to be sent securely). However, once a very long pad has been securely sent (e.g., a computer disk full of random data), it can be used for numerous future messages, until the sum of their sizes equals the size of the pad. Quantum key distribution also proposes a solution to this problem.

Distributing very long one-time pad keys is inconvenient and usually poses a significant security risk. The pad is essentially the encryption key, but unlike keys for modern ciphers, it must be extremely long and is much too difficult for humans to remember. Storage media such as thumb drives, DVD-Rs or personal digital audio players can be used to carry a very large one-time-pad from place to place in a non-suspicious way, but even so the need to transport the pad physically is a burden compared to the key negotiation protocols of a modern public-key cryptosystem, and such media cannot reliably be erased securely by any means short of physical destruction (e.g., incineration). A 4.7 GB DVD-R full of one-time-pad data, if shredded into particles 1 mm² in size, leaves over 4 megabits of (admittedly hard to recover, but not impossibly so) data on each particle. [citation needed] In addition, the risk of compromise during transit (for example, a pickpocket swiping, copying and replacing the pad) is likely to be much greater in practice than the likelihood of compromise for a cipher such as AES. Finally, the effort needed to manage one-time pad key material scales very badly for large networks of communicants—the number of pads required goes up as the square of the number of users freely exchanging messages. For communication between only two persons, or a star network topology, this is less of a problem.

The key material must be securely disposed of after use, to ensure the key material is never reused and to protect the messages sent. Because the key material must be transported from one endpoint to another, and persist until the message is sent or received, it can be more vulnerable to forensic recovery than the transient plaintext it protects (see data remanence).

Authentication

As traditionally used, one-time pads provide no message authentication, the lack of which can pose a security threat in real-world systems. For example, an attacker who knows that the message contains “meet Jane and me tomorrow at three thirty pm” can derive the corresponding codes of the pad directly from the two known elements (the encrypted text and the known plaintext). The attacker can then replace that text by any other text of exactly the same length, such as “three thirty meeting is canceled, stay home”, The attacker's knowledge of the one-time pad is limited to this byte length, which must be maintained for any other content of the message to remain valid. This is a little different from malleability where it is not taken necessarily that the plaintext is known. See also stream cipher attack.

Standard techniques to prevent this, such as the use of a message authentication code can be used along with a one-time pad system to prevent such attacks, as can classical methods such as variable length padding and Russian copulation, but they all lack the perfect security the OTP itself has. Universal hashing provides a way to authenticate messages up to an arbitrary security bound (i.e., for any p>0, a large enough hash ensures that even a computationally unbounded attacker's likelihood of successful forgery is less than p), but this uses additional random data from the pad, and removes the possibility of implementing the system without a computer.

True Randomness

High-quality random numbers are difficult to generate. The random number generation functions in most programming language libraries are not suitable for cryptographic use. Even those generators that are suitable for normal cryptographic use, including/dev/random and many hardware random number generators, may make some use of cryptographic functions whose security has not been proven. An example of how true randomness can be achieved is by measuring radioactive emissions.

In particular, one-time use is absolutely necessary. If a one-time pad is used just twice, simple mathematical operations can reduce it to a running key cipher. If both plaintexts are in a natural language (e.g., English or Russian) then, even though both are secret, each stands a very high chance of being recovered by heuristic cryptanalysis, with possibly a few ambiguities. Of course the longer message can only be broken for the portion that overlaps the shorter message, plus perhaps a little more by completing a word or phrase. The most famous exploit of this vulnerability occurred with the Venona project.

Uses

Applicability

Any digital data storage device can be used to transport one-time pad data.

Despite its problems, the one-time-pad retains some practical interest. In some hypothetical espionage situations, the one-time pad might be useful because it can be computed by hand with only pencil and paper. Indeed, nearly all other high quality ciphers are entirely impractical without computers. Spies can receive their pads in person from their “handlers.” In the modern world, however, computers (such as those embedded in personal electronic devices such as mobile phones) are so ubiquitous that possessing a computer suitable for performing conventional encryption (for example, a phone which can run concealed cryptographic software) may usually not attract suspicion.

The one-time-pad is the optimum cryptosystem with theoretically perfect secrecy.

The one-time-pad is one of the most practical methods of encryption where one or both parties must do all work by hand, without the aid of a computer. This made it important in the pre-computer era, and it could conceivably still be useful in situations where possession of a computer is illegal or incriminating or where trustworthy computers are not available.

One-time pads are practical in situations where two parties in a secure environment must be able to depart from one another and communicate from two separate secure environments with perfect secrecy.

The one-time-pad can be used in superencryption.

The algorithm most commonly associated with quantum key distribution is the one-time pad.

The one-time pad is mimicked by stream ciphers.

The one-time pad can be a part of an introduction to cryptography. [24]

Historical Uses

One-time pads have been used in special circumstances since the early 1900s. In 1923, it was employed for diplomatic communications by the German diplomatic establishment. The Weimar Republic Diplomatic Service began using the method in about 1920. The breaking of poor Soviet cryptography by the British, with messages made public for political reasons in two instances in the 1920s (ARCOS case), appear to have induced the U.S.S.R. to adopt one-time pads for some purposes by around 1930. KGB spies are also known to have used pencil and paper one-time pads more recently. Examples include Colonel Rudolf Abel, who was arrested and convicted in New York City in the 1950s, and the ‘Krogers’ (i.e., Morris and Lona Cohen), who were arrested and convicted of espionage in the United Kingdom in the early 1960s. Both were found with physical one-time pads in their possession.

A number of nations have used one-time pad systems for their sensitive traffic. Leo Marks reports that the British Special Operations Executive used one-time pads in World War II to encode traffic between its offices. One-time pads for use with its overseas agents were introduced late in the war.[13] A few British one-time tape cipher machines include the Rockex and Noreen. The German Stasi Sprach Machine was also capable of using one time tape which East Germany, Russia, and even Cuba used to send encrypted messages to their agents.

The World War II voice scrambler SIGSALY was also a form of one-time system. It added noise to the signal at one end and removed it at the other end. The noise was distributed to the channel ends in the form of large shellac records which were manufactured in unique pairs. There were both starting synchronization and longer-term phase drift problems which arose and were solved before the system could be used.

The hotline between Moscow and Washington D.C., established in 1963 after the Cuban missile crisis, used teleprinters protected by a commercial one-time tape system. Each country prepared the keying tapes used to encode its messages and delivered them via their embassy in the other country. A unique advantage of the OTP in this case was that neither country had to reveal more sensitive encryption methods to the other.

U. S. Army Special Forces used one-time pads in Vietnam. By using Morse code with one-time pads and continuous wave radio transmission (the carrier for Morse code), they achieved both secrecy and reliable communications.[citation needed]

During the 1983 Invasion of Grenada, U.S. forces found a supply of pairs of one-time pad books in a Cuban warehouse.

Starting in 1988, the African National Congress (ANC) used disk-based one-time pads as part of a secure communication system between ANC leaders outside South Africa and in-country operatives as part of Operation Vula, a successful effort to build a resistance network inside South Africa. Random numbers on the disk were erased after use. A Belgian airline stewardess acted as courier to bring in the pad disks. A regular resupply of new disks was needed as they were used up fairly quickly. One problem with the system was that it could not be used for secure data storage. Later Vula added a stream cipher keyed by book codes to solve this problem.

A related notion is the one-time code—a signal, used only once, e.g., “Alpha” for “mission completed”, “Bravo” for “mission failed” or even “Torch” for “Allied invasion of French Northern Africa” [30] cannot be “decrypted” in any reasonable sense of the word. Understanding the message may require additional information, often ‘depth’ of repetition, or some traffic analysis. However, such strategies (though often used by real operatives, and baseball coaches) are not a cryptographic one-time pad in any significant sense.

NSA

At least into the 1970s, the U.S. National Security Agency (NSA) produced a variety of manual one-time pads, both general purpose and specialized, with 86,000 one-time pads produced in fiscal year 1972. Special purpose pads were produced for what NSA called “pro forma” systems, where “the basic framework, form or format of every message text is identical or nearly so; the same kind of information, message after message. is to be presented in the same order, and only specific values, like numbers, change with each message.” Examples included nuclear launch messages and radio direction finding reports (COMUS).

General purpose pads were produced in several formats, a simple list of random letters (DIANA) or just numbers (CALYPSO), tiny pads for covert agents (MICKEY MOUSE), and pads designed for more rapid encoding of short messages, at the cost of lower density. One example, ORION, had 50 rows of plaintext alphabets on one side and the corresponding random cipher text letters on the other side. By placing a sheet on top of a piece of carbon paper with the carbon face up, one could circle one letter in each row on one side and the corresponding letter one the other side would be circled by the carbon paper. Thus one ORION sheet could quickly encode or decode a message up to 50 characters long. Production of ORION pads required printing both sides in exact registration, a difficult process, so NSA switched to another pad format, MEDEA, with 25 rows of paired alphabets and random characters. (See Commons: Category: NSA one-time pads for illustrations.)

The NSA also built automated systems for the “centralized headquarters of CIA and Special Forces units so that they can efficiently process the many separate one-time pad messages to and from individual pad holders in the field.”

During World War II and into the 1950s, the U.S. made extensive use of one-time tape systems. In addition to providing confidentiality, circuits secured by one-time tape ran continually, even when there was no traffic, thus protecting against traffic analysis. In 1955, NSA produced some 1,660,000 rolls of one time tape. Each roll was 8 inches in diameter, contained 100,000 characters, lasted 166 minutes and cost $4.55 to produce. By 1972, only 55,000 rolls were produced, as one-time tapes were replaced by rotor machines such as SIGTOT, and later by electronic devices based on shift registers.[31]: pp. 39-44 The NSA describes one-time tape systems like 5-UCO and SIGTOT as being used for intelligence traffic until the introduction of the electronic cipher based KW-26 in 1957.

Exploits

While one-time pads provide perfect secrecy if generated and used properly, small mistakes can lead to successful cryptanalysis:

In 1944-1945, the U.S. Army's Signals Intelligence Service was able to solve a one-time pad system used by the German Foreign Office for its high-level traffic, codenamed GEE.[33] GEE was insecure because the pads were not completely random—the machine used to generate the pads produced predictable output.

In 1945, the US discovered that Canberra—Moscow messages were being encrypted first using a code-book and then using a one-time pad. However, the one-time pad used was the same one used by Moscow for Washington, D.C.-Moscow messages. Combined with the fact that some of the Canberra-Moscow messages included known British government documents, this allowed some of the encrypted messages to be broken.

One-time pads were employed by Soviet espionage agencies for covert communications with agents and agent controllers. Analysis has shown that these pads were generated by typists using actual typewriters. This method is of course not truly random, as it makes certain convenient key sequences more likely than others, yet it proved to be generally effective because while a person may not produce truly random sequences, they equally do not follow the same kind of structured mathematical rules that a machine would either, and each person generates ciphers in a different way making attacking any message challenging. Without copies of the key material used, only some defect in the generation method or reuse of keys offered much hope of cryptanalysis. Beginning in the late 1940s, US and UK intelligence agencies were able to break some of the Soviet one-time pad traffic to Moscow during WWII as a result of errors made in generating and distributing the key material. One suggestion is that Moscow Centre personnel were somewhat rushed by the presence of German troops just outside Moscow in late 1941 and early 1942, and they produced more than one copy of the same key material during that period. This decades-long effort was finally codenamed VENONA (BRIDE had been an earlier name); it produced a considerable amount of information, including more than a little about some of the Soviet atom spies. Even so, only a small percentage of the intercepted messages were either fully or partially decrypted (a few thousand out of several hundred thousand).

The one-time tape systems used by the U.S. employed electromechanical mixers to combine bits from the message and the one-time tape. These mixers radiated considerable electromagnetic energy that could be picked up by an adversary at some distance from the encryption equipment. This effect, first noticed by Bell Labs during World War II, could allow interception and recovery of the plaintext of messages being transmitted, a vulnerability code-named Tempest.

Type of Measurement

Measurement types can be categorized by the associated physical properties they represent. Individuals conducting measurements should understand the purpose of the measurement. This section describes these properties and their respective measuring methodologies. The corresponding equipment descriptions are included in a subsequent section.

3.1 Electrical

Electric power and energy are typically the most important measurements for savings evaluations. As electric power is commonly a direct measurement of the energy use of a load, it may be the only measurement needed to determine savings between a base case and high efficiency measure. The common unit of power is kilowatts (kW). The common unit of energy is kilowatt-hour (kWh). Energy is power used during a unit of time. Other electrical measurements are voltage (V), current in amperes (A), and power factor (PF). Although direct current voltage (Vdc) is used to power some types of equipment, utility transmission to customers occurs in the form of alternating current voltage (Vac). For this discussion, A and V are expressed in terms of alternating current, and the values measured or recorded are the root mean square (RMS) values. In general terms, RMS is the common presentation of alternating current electrical measurements. Apparent power (V·A) multiplied by the power factor equals the true power (W=V·A·PF).

Power factor is given by the following:
For perfect sinusoidal waveforms, the power factor is the cosine of the angle of the phase shift between the current and the voltage.⋅ If the voltage and current waveform

are non-sinusoidal, the definition of power factor is (V·A)/W.

3.1.1

Considerations

There are important safety and metering considerations associated with conducting power measurements. Only an electrician, an electrical engineer, or a technician with training and proper equipment should be allowed to work in live electrical panels. Also, the individuals conducting this work should know and follow codes and guidelines provided by the National Electric Code (NEC), the Occupational Safety and Health Administration (OSHA), and the National Institute for Occupational Safety and Health (NIOSH). Additionally, personal protective equipment (PPE) that complies with National Fire Protection Association (NFPA) 70E should be worn to protect against arc flash in open electrical cabinets.

Electrical measurements should be limited to 600 V or less. Due to spark gaps from the high voltage, only electrical linemen with special training and equipment should work on systems above 600 V. Some facilities have existing current and voltage sensors in place on systems greater than 600 V that can be safely utilized to make measurements.

Current metering rather than power metering (Note that power metering is also referred to as kW metering, and Current metering is also referred to as Amp metering) can be considered if:
The load has a stable or well-defined power factor and the interval of recording is short relative to the system cycle.
The metering is only to determine operating hours.

When conducting current metering, additional analysis is needed to convert current data to power data. Harmonics are produced by electronic loads. These non-sinusoidal waveforms can only be accurately measured by meters designed to make true RMS measurements.

Single Phase Vs. Three-Phase Loads

The two common standard voltages utilities provide to most commercial customers are three-phase 120/208 V or 277/480 V. The term “277/480 V” signifies that the voltage from any one of the phases to ground is 277 V and the voltage from one phase to another phase is 480V.
The two main types of three-phase electrical systems are wye and delta.
Wye systems are three-phase and four-wire, where the fourth wire is neutral.
Delta systems are three-phase and three-wire.

There are several less common variations with grounding differences relative to the active voltage legs.

Residential supply voltage is 120/240 V and is single phase. It uses a three-wire configuration consisting of two hot legs and one neutral.

While lighting is a single-phase load, most motors are three-phase loads. Three-phase motors are assumed to be balanced, which means the current draw is equal in each of the three phases. In practice, however, the three-phase currents are not always identical.

One-Time Pad encryption is the only encryption mechanism that is considered to be “unbreakable”. The basic constraint of an OTP implementation is to have a live and continuous source of random data to work with. This can be accomplished by utilizing measurement devices such as Internet of Things sensor devices to create random sequences based potentially on sensor input, and then transmit the random data to cloud storage for real-time and/or future use. The easiest example of this could be to measure voltage output from various electrical flows throughout the electrical grid, and feed those voltage fluctuations on timed sample rates to a cloud storage database.

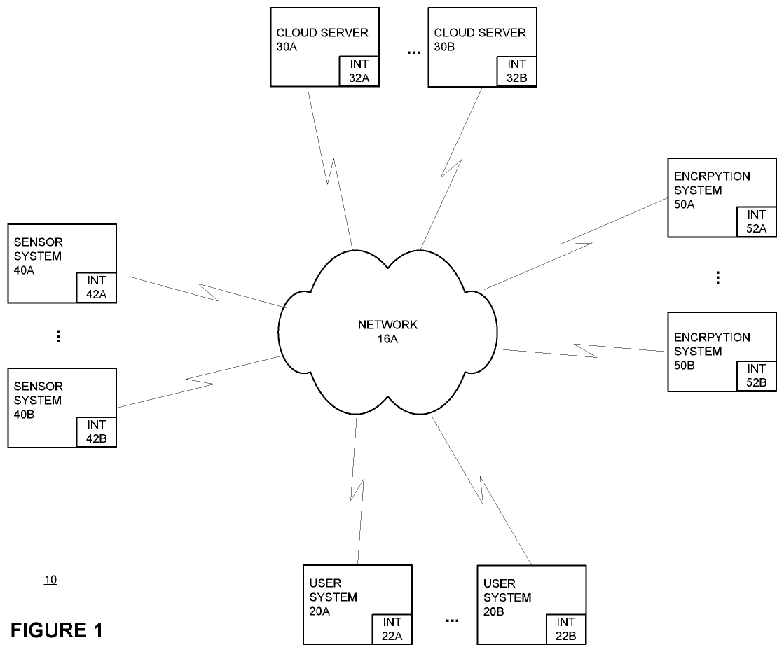

FIG. 1 is a block diagram of a sensor data based encryption (SDBE) architecture 10 according to various embodiments. As shown in FIG. 1, the SDBE architecture 10 may include sensor systems 40A, 40B that may be coupled to a network 16A via interfaces 42A, 42B, cloud servers 30A, 30B that may be coupled to a network 16A via interfaces 32A, 32B, encryption systems 50A, 50B that may be coupled to a network 16A via interfaces 52A, 52B, and User systems 20A, 20B that may be coupled to a network 16A via interfaces 22A, 22B. In an embodiment, any of the systems 40A, 20A, 50A, and cloud servers 30A may be coupled to the network 16A via wired or wireless connections and may be coupled directly to each other via wired or wireless connections. In an embodiment, the sensor system 40A may be part of an IOT architecture 30A, 30B shown in FIGS. 3A and 3B.

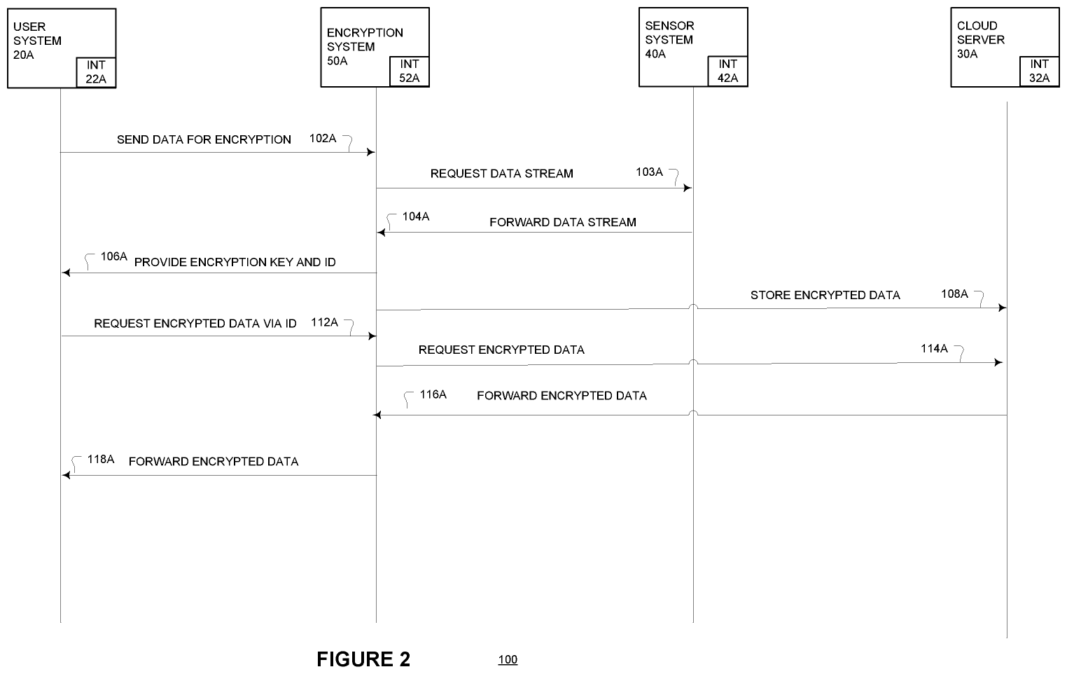

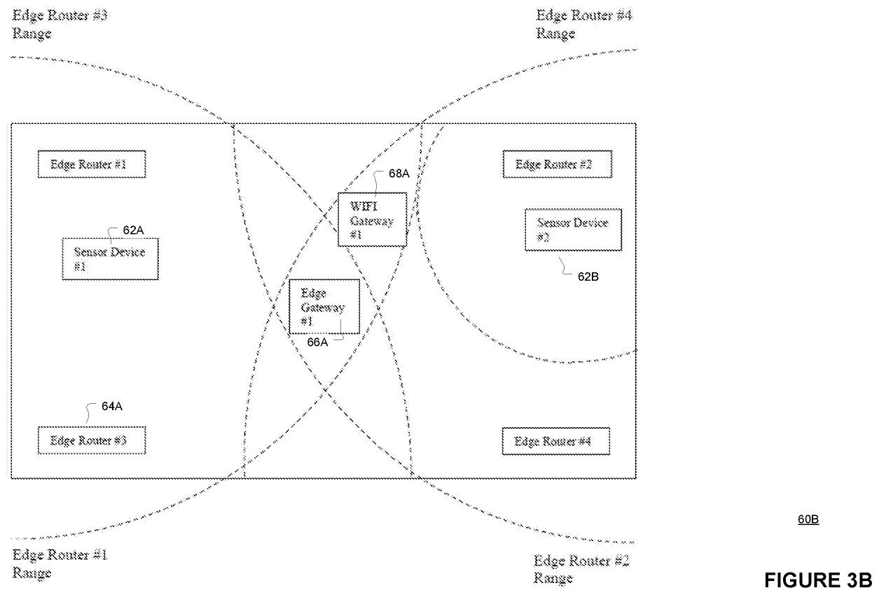

In an embodiment, a User via a user system 20A may desire to securely encrypt data (activity 152 of algorithm 150 shown in FIG. 4). The User via their system 20A may send the data to an encryption system 50A (communication 102A of communications 100 shown in FIG. 2). The encryption system 50A may request or continuously receive random data from a sensor system 40A (communication 103A, 104A and activities 154, 156). As noted, the sensor data may be random and coupled to a timer that provide an effective ID for the random sensor data, which may form the encryption key and ID for the data that encryption system 50A may encrypt for a User (activity 158 and communications 106A). The encryption system may store the User encrypted data locally or in a various cloud servers 30A including block chain type systems (activity 162, communication 108A).

In an embodiment, when a User wants to decode their encrypted data they via their system 20A may send the ID for the encrypted data to the encryption system 50A (communication 112A). The encryption system 50A may retrieve the encrypted data from storage (communications 114A, 116A). The encryption system 50A may then forward the encrypted data to the User device for decoding (communication 118A). In an embodiment, a User system 20A may provide the ID and encryption key to the encryption system 50A to decode the data. In a further embodiment, the sensor data that forms the encryption key may be forwarded directly to the User system 20A.

Other sensor based information that fluctuates randomly over a timed sequence could also be utilized for such an implementation. Perhaps the most random means of sensor measurement could be based on the concept of what most scientists consider truly random sequencing; radioactive decay of isotopes. However, the most readily available source of radiation based on nuclear reaction is sunlight. If solar panels were to transmit frequent sample rates of conduction during hours of sunlight on a regional or global scale, the data stream would be representing nuclear reaction fluctuations consistent with solar radiation and/or nuclear reactions by the Sun. This should create a constantly producing random number sequence that would be non-repeating and in no way reproducible with earth-bound technology. The random number sequence produced in this manner could be stored in an immutable data store such as a blockchain, and used in real-time or at a later date to perform cryptographic sequencing for an OTP implementation.

Once random data is collected, it can be used in a One-Time Pad implementation by allowing the data that needs to be secured to be encrypted in a manner consistent with a OTP implementation. Once the data is modified, it can be stored on a blockchain or other ledger and then the OTP key data can be securely sent to the party of interest for decryption at a later time. The corresponding random data used to encrypt the user data should then be deleted from the data store altogether so that the encrypted data can only be recovered by the person that requested the encryption to begin with.

Another implementation of OTP could be to have constantly changing measurements form IoT devices sent to a server or cloud-based environment for use. This constantly changing measurement stream could be generated by measuring the electrical flow from solar panels equipped with highly sensitive measurement equipment. Of course, on a global scale any combination of sensor data could be used to create a random number stream, including solar voltage readings from PV panels, electromagnetic measurements, heat sensors over thermal features such as active volcanos and geysers, or other natural events and occurrences that fluctuate energy release over time and/or the time interval between voltage fluctuations for variance in the data stream. Another way to produce a random data stream (least recommended of course) would be to have radioactive isotopes with a fairly long radioactive decay half-life monitored by a Geiger counter and have the time in between the release of electrons recorded and turned into a random data stream. Alternately, a suitable random number stream could be generated from human interaction such as smartphones and computers, or without interaction with computing devices such as smartphones and computers, or any combination of the above. For instance, smartphones can achieve a high degree of ongoing random number generation from the barometric pressure, magnetic field, and inclination sensors without human interaction. With human interaction, the variations become more sophisticated. The random number stream could be constantly transmitted over a network, possibly encrypted with SSL, TLS, or SSL over web sockets, to a server or cloud environment. As the random number stream feeds through the server or cloud environment in a constant or burst data segment, it can be utilized at any time for encryption purposes.

Consider the following transaction. An entity wants to encrypt data and have it stored in an immutable ledger for safe storage and later recovery. The entity transmits their data to the server or cloud environment for encrypting and storage. Once the data packet arrives, the server or cloud environment then notes a timestamp of when the message is being encrypted and proceeds to capture as much data is needed to encrypt the user data in an OTP manner. The random number sequence may also be normalized to a clock on the computing environment in that it only records a data measurement for each of the most precise units of time that can be measured by the server or cloud computers. This may ensure that the data sequence stays in order during encryption. As a possible example, if the user submits a 50 character packet of data for securing, then a 50 or more number sequence needs to be captured in memory from the precise time the encryption request is made to the server or cloud environment. The initial data is encrypted in a manner consistent with OTP encryption methods. If additional data is captured, then it can be used to further encrypt the data with a hash algorithm or pad the data packet with data to further obfuscate the final encrypted packet. Once the data is encrypted, the random sequence used to encrypt the data (which becomes the decryption key) should be sent back to the user in a secure manner, and the encrypted data is written to a ledger with the timestamp of when the encryption sequence started to be used as the label, header, or unique id for the encrypted packet. The timestamp or unique id for looking up the data packet on the ledger at a later time can be sent back during the finalization of the transaction, or through some other form of communication such as text message to a mobile device, email, or some other form of communication.

Think of the transmission of the timestamp or unique id as a second verification for each transaction, similar to the “two-step verification” process in use at several major banks. When you log into most online email services, you for some time now have had the opportunity to enable two step verification. The initial transaction may only involve the user initiating the transaction by submitting the record or document for encryption and storage on a ledger. The OTP implementation may encrypt the data, and then send the decryption key back to the user. Then, the unique id to lookup the data may be sent via text message, email or some other form of communication. This should protect the user from most security issues.

More sophisticated lookup schemes can be implemented that may involve a user's username, id, or other forms of identification to assist in securing and retrieving data in this OTP implementation. One important potential design aspect is that the random number stream may never in itself be written to storage unless required to implement the encryption scheme in use. Otherwise, the random number stream should constantly flow to the server or cloud environment to increase security as well as facilitate the OTP scheme. This encrypted ledger system should be constructed in a manner such that the encrypted packet or record should have a lookup id that is unique globally and based on the timestamp of when the encryption started as well as any other identifiable information used to encrypt the data. The ledger storage should then record the encrypted data itself in a manner that is considered immutable and/or untamperable. Of course, this encrypted ledger may differ significantly from a blockchain implementation, whereby each packet contains a hashed address or location of the next block in the chain. This OTP implementation may require that no encrypted data packet has to reference another encrypted data packet. The data packets just have to be searchable from the unique id standpoint for retrieval by the user. Another possible identification mechanism could be to incorporate an IP address into the unique id so that the encrypted packet can be located in a fully distributed computing environment. If each encrypted packet should reference the next packet in the sequence, then some hashing or other mechanism can be incorporated in a manner in which the OTP implementation encrypts not only the user data but additional information that references the next encrypted packet in the ledger.

There are several advantages of this OTP implementation over a blockchain:

The OTP encryption calculation is much faster than executing a standard PKI encryption algorithm (AES, 3DES, etc.) over data.

OTP isn't vulnerable to any dictionary or brute force attacks.

The OTP mechanism described herein doesn't store the encryption key server-side so once a transaction is completed, the user knows the key is in their possession exclusively.

All other blockchain ledgers have limits on their size. This OTP implementation can increase in size indefinitely without performance degradation.

PKI really wasn't designed to be used in an immutable encrypted ledger model because it isn't a two-way origination of the communication and doesn't require identification of both parties through third-party authorization (Certificate Authorities) to conduct a transaction. It is just a user of the system and the computing environment where records are stored and retrieved. Therefore, key-pair encryption schemes create unnecessary overhead when compared to OTP implementations.

If quantum computers are created in the near future, they could be used to compromise every encryption scheme being used on earth, including PKI schemes currently in use by the cryptocurrency markets. This OTP implementation would eliminate that threat altogether as it isn't susceptible to brute force, dictionary attacks or other methods that can be used to break PKI based encryption schemes.

The notion of a constant stream of random data from sensors may allow for several major advancements in computing architecture related to secure blockchains as well as cryptocurrency implementations. The above model could also be coupled with a hardware design that supports a write once and read only storage facility. Then the packets of encrypted data can be written into storage with the guarantee that they haven't been altered at any point in the future. Think of CD-R vs CD_RW. Current storage implementations on the Internet that include SCSI drives, SSD drives. If they were manufactured to work like CR-R drives, then encrypted data could be written to them and be guaranteed that they are never altered in the future.

This OTP encryption model also supports the notion of “Encryption as a Service” where any user of the system can choose to encrypt and/or store on a ledger information they believe to be important. This mechanism can also be used in cryptocurrency and/or securities markets to provide the best overall encryption security to users of such systems. Encrypted packets could be linked to each other in a “chain” fashion, but ultimately with OTP encryption to a ledger, encrypted packets don't have to necessarily be “linked” to each other as in all current blockchain implementations. The OTP model may virtually eliminate overhead on electricity needed to participate in creating records or cryptocurrency units on a ledger, while providing the only encryption scheme that has been universally accepted as the only “unbreakable” encryption scheme created to date. Ledgers for this OTP model can be private and/or public based on market requirements. This OTP implementation can benefit payment systems as it would minimize execution time per transaction and dramatically speed up payment processing when compared to current blockchain implementations. OTP may also eliminate the issues Bitcoin are dealing with currently on ledger size bringing data mining of the network to a halt, permanently. OTP would also eliminate the threat quantum computing imposes on current PKI-based security models. Another method of this OTP model would be to perform the transactions over a web socket, which drops the IP communication from level 6 to level 4. The benefit of this is that the transaction can still communicate over an encrypted channel such as SSL, but it won't be as easy to “sniff” the data packet over the wire, or intercept the data traffic due to the fact that the communications are running on layer 4 of the Internet Protocol stack instead of layer 6 (your web browser and most other Internet enabled apps run on IPv6). In addition, it may allow for the client and server applications to conduct the transaction in a single send-receive request over the network once the web socket channel is established. This OTP design may further enhance the security model and improve overall user experience.

Another consideration of this OTP design is that the PKI complexities of talking to third party Certificate Authorities over the network to confirm identity unnecessarily has been removed. Therefore, more enhanced network architectures can be considered to expedite transactions. Consider a central repository where all the random data is streaming into, and OTP encryption occurs in real-time. Then, consider having several cloud-based servers running web socket proxies to that central repository. If the network is designed in such a way that the web socket proxy servers are spread out over the global Internet, then digital wallet applications and any other applications that want to use this OTP mechanism can interact through a local server that has a dedicated communication channel to the repository performing all the real-time encryption and storage of records to a ledger. This network architecture may dramatically scale to meet the demands of a global payment, record and document storage facility with virtually zero network latency.

One other important matter to consider for this encryption service is that once a data packet/document/etc. is transmitted to the service, the data is encrypted and then stored, at a minimum the encryption key, and/or possibly the encrypted packet/document/etc. itself may need to be transmitted back to the user that initiated the transaction. The key and/or the encrypted data can be transmitted back to the user in the same secure data channel that they initiated the transaction from (possibly SSL, TLS, SSL over a web socket, etc.) either together or in separate transactions. Another mechanism to perform this action would be to have the encrypted packet or the key transmitted back in the same transaction via the same protocol, and then have the other piece of information being the key or the data transmitted back over another transaction or alternate communications channel. For instance, the encrypted packet can be sent back on the same transaction and the key can then be transmitted back through text messaging or email. Either response from the server to gain access to the encrypted data or the encryption key could simply be a secure link to retrieve the data as a separate transaction. Any combination of using multiple communications transactions and mediums could be used to transmit the resultant information from the service, whether it be the encrypted data, the encryption key, or information provided to retrieve either piece of information in the future. This service should also provide a secure mechanism that allows encrypted data and/or an associated encryption key to be securely submitted for decryption of the information. Once the decrypted information is produced, it can then be used by another secure service or returned to the user in a manner described in this disclosure.

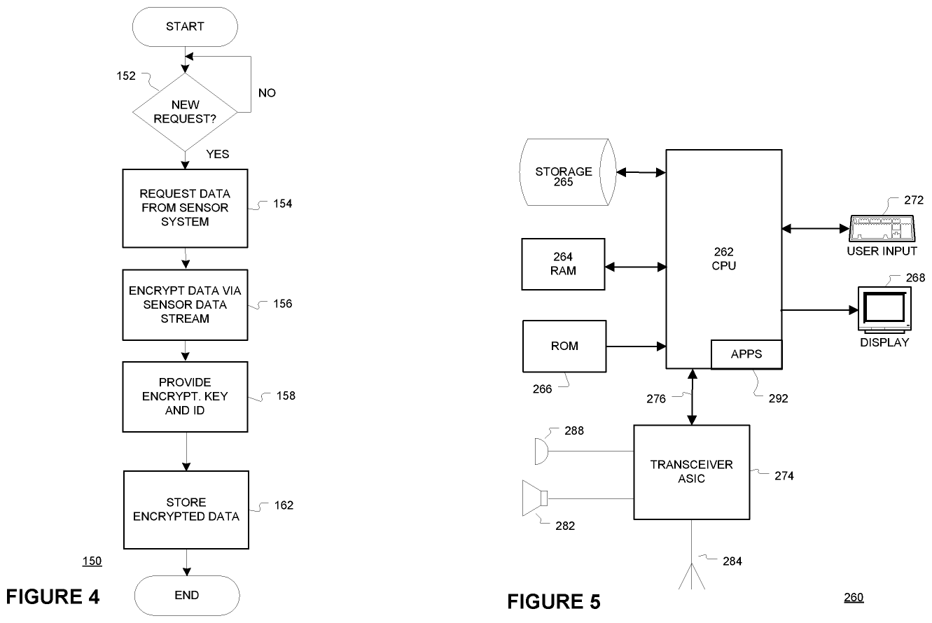

A device 260 is shown in FIG. 5 that may be used in various embodiments as a User system 20A, an encryption system 50A, a sensor system 40A, and a cloud server 30A. The device 260 may include a central processing unit (CPU) 262, a random-access memory (RAM) 264, a read only memory (ROM”) 266, a display 268, an input device 272, a transceiver application specific integrated circuit (ASIC) 274, a microphone 288, a speaker 282, a storage unit 265, and an antenna 284. The CPU 262 may include an application module 292 including a browser application module. The RAM 264 may store user, sensor, an encrypted data.

In an embodiment, the applications 292 may be a separate module. The application module 292 may used to encrypt or decrypt data. The storage device 265 may comprise any convenient form of data storage and may be used to store temporary program information, queues, databases, and overhead information.

The ROM 266 may be coupled to the CPU 262 and may store the program instructions to be executed by the CPU 262, and the application module 292. The RAM 264 may be coupled to the CPU 262 and may store temporary program data, sensor data, and overhead information. The user input device 272 may comprise an input device such as a keypad, touch screen, track ball or other similar input device that enables a user to navigate through menus, displays in order to operate the device 260. The display 268 may be an output device such as a CRT, LCD, touch screen, or other similar screen display that enables the user to read, view, or hear received messages, displays, or pages from the encryption system 50A interface 52.

A microphone 288 and a speaker 282 may be incorporated into the device 260. The microphone 288 and speaker 282 may also be separated from the device 260. Received data may be transmitted to the CPU 262 via a bus 276 where the data may include messages, displays, or pages received, messages, displays, or pages to be transmitted, or protocol information. The transceiver ASIC 274 may include an instruction set necessary to communicate messages, displays, or pages in architecture 10. The ASIC 274 may be coupled to the antenna 284 to communicate wireless messages, displays, or pages within the architecture 10. When a message is received by the transceiver ASIC 274, its corresponding data may be transferred to the CPU 262 via the bus 276. The data can include wireless protocol, overhead information, and pages and displays to be processed by the device 260 in accordance with the methods described herein.

Any of the components previously described can be implemented in a number of ways, including embodiments in software. Any of the components previously described can be implemented in a number of ways, including embodiments in software. Thus, the CPU 232, web-server 254, application module 252, modem/transceiver 244, antenna 246, storage 238, RAM 234, ROM 236, database 248, database 256, CPU 262, application module 292, transceiver ASIC 274, antenna 284, microphone 288, speaker 282, ROM 266, RAM 264, user input 272, display 268, encryption system 50A, sensor system 40A, cloud server 30A, and User system 20A, may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments.

The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, may be apparent to those of skill in the art upon reviewing the above description.

The Abstract of the Disclosure is provided to comply with 37 C.F.R. § 1.72(b), requiring an abstract that may allow the reader to quickly ascertain the nature of the technical disclosure. It is submitted with the understanding that it may not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

1. A method of forming encrypted data for a plurality of User data, including:
receiving plurality data from a physical data sensor;
encrypting the plurality of User data via the plurality of received sensor data;
forwarding an encryption key and encrypted data identifier to a User electronically; and
storing the encrypted data and its identifier.

2. The method of forming encrypted data for a plurality of User data according to claim 1, wherein the sensor data is electrical energy measurement data.

3. The method of forming encrypted data for a plurality of User data according to claim 1, wherein the sensor data is radiation measurement data.

4. The method of forming encrypted data for a plurality of User data according to claim 1, wherein the sensor data is solar energy measurement data.

5. The method of forming encrypted data for a plurality of User data according to claim 1, wherein the sensor data is collected from an Internet of Things device incorporating a sensor to measure and collect the sensor data.

6. The method of forming encrypted data for a plurality of User data according to claim 1, wherein forming a One time Pad (OTP) with via the plurality of received sensor data and encrypting the plurality of User data via the OTP.

7. The method of forming encrypted data for a plurality of User data according to claim 1, including storing the encrypted data and its identifier in an offline server.

8. The method of forming encrypted data for a plurality of User data according to claim 1, including storing the encrypted data and its identifier in a cloud server.

9. The method of forming encrypted data for a plurality of User data according to claim 1, including storing the encrypted data and its identifier in a block chain server.

10. The method of forming encrypted data for a plurality of User data according to claim 5, wherein forming a One time Pad (OTP) with via the plurality of received sensor data and encrypting the plurality of User data via the OTP.

11. The method of forming encrypted data for a plurality of User data according to claim 5, including storing the encrypted data and its identifier in a cloud server.

12. The method of forming encrypted data for a plurality of User data according to claim 5, including storing the encrypted data and its identifier in a block chain server.

13. The method of forming encrypted data for a plurality of User data according to claim 5, wherein the sensor data is electrical energy measurement data.

14. The method of forming encrypted data for a plurality of User data according to claim 5, wherein the sensor data is radiation measurement data.

15. The method of forming encrypted data for a plurality of User data according to claim 5, wherein the sensor data is solar energy measurement data.

16. The method of forming encrypted data for a plurality of User data according to claim 6, wherein the sensor data is electrical energy measurement data.

17. The method of forming encrypted data for a plurality of User data according to claim 6, wherein the sensor data is radiation measurement data.

18. The method of forming encrypted data for a plurality of User data according to claim 6, wherein the sensor data is solar energy measurement data.
